(19) United States
(12) Patent Application Publication
(10) Pub. No.: US 2025/0219170 A1
(43) Pub. Date: Jul. 3, 2025

(54) BATTERY MANUFACTURING SYSTEM AND CONTROLLING METHOD OF THE SAME

(71) Applicant: SK On Co., Ltd., Seoul (KR)

(72) Inventors: Jeong Woo KIM, Daejeon (KR); Tae Hyun PARK, Daejeon (KR); Hyeon Cheol CHO, Daejeon (KR); Jung Yeon RYU, Daejeon (KR)

(21) Appl. No.: 19/004,471

(22) Filed: Dec. 30, 2024

(30) Foreign Application Priority Data
Jan. 2, 2024 (KR) 10-2024-0000272

(51) Int. Cl. H01M 10/44

(52) U.S. Cl. CPC H01M 10/441; H01M 10/446

(57) ABSTRACT

The present disclosure relates to a battery manufacturing system including: a first rack and a second rack, each of which includes a charging and discharging room including an inlet on one surface and accommodating a plurality of battery cells through the inlet, and which are aligned in parallel with each other; and a transport crane, which is provided between the first rack and the second rack, introduces and withdraws a plurality of battery cells accommodated in a charging and discharging transport member into and out of the charging and discharging room through the inlets arranged to face each other, and is movable in the height direction of the first rack or the second rack and in a direction perpendicular to the height direction, and a controlling method thereof.

### CROSS-REFERENCE TO RELATED PATENT APPLICATION

The present application claims priority under 35 U.S.C. § 119(a) to Korean patent application number 10-2024-0000272 filed on Jan. 2, 2024 in the Korean Intellectual Property Office, the entire disclosure of which is incorporated by reference herein.

### BACKGROUND OF THE INVENTION

### 1. Field

The present disclosure relates to a battery manufacturing system for manufacturing battery cells and a controlling method of the same.

### 2. Description of the Related Art

In a manufacturing process for manufacturing battery cells, a transport member (or tray) that transports a plurality of battery cells is used to move from one process to another. The transport member may be controlled to move between individual processes by a conveyor belt. In addition, devices used in each process may be controlled to insert or withdraw a transport member into or from the corresponding device by using equipment referred to as multiple stacker crane (MSC).

In particular, in a press pre-charger (PPC) device that charges and discharges battery cells under pressure during a charging and discharging process, a transport member of different specifications from the transport members used in other general processes is used. Therefore, a device that transfers battery cells between transport members is required. In addition, an exclusive conveyor belt for a charging and discharging process is required to efficiently utilize a transport member that transports battery cells in a charging and discharging process and an empty transport member after transporting the battery cells and to remove a transport member that transports battery cells when a defect is generated during a charging and discharging process.

### SUMMARY OF THE INVENTION

According to one aspect of the present disclosure, a technical problem is to efficiently utilize the space where a charging and discharging device is positioned.

According to another aspect of the present disclosure, a technical problem is to organically utilize a transport member.

According to still another aspect of the present disclosure, a technical problem is to enable a transport member to be removed separately when a defect is generated.

According to yet another aspect of the present disclosure, a technical problem is to increase the production efficiency of a battery manufacturing system and stably control the battery manufacturing system.

Meanwhile, the battery cells manufactured using the battery manufacturing system according to the present disclosure can be widely applied in the field of electric vehicles, battery charging stations, and green technology, such solar power generation, and wind power generation using batteries. In addition, the battery cells manufactured using the battery manufacturing system according to the present disclosure can be used in eco-friendly mobility including electric vehicles, hybrid vehicles, and others to prevent air pollution and climate change by suppressing greenhouse gas emissions.

A battery manufacturing system according to the present disclosure includes: a first rack and a second rack, each of which includes a charging and discharging room including an inlet on one surface and accommodating a plurality of battery cells through the inlet, and which are aligned in parallel with each other; and a transport crane, which is provided between the first rack and the second rack, introduces and withdraws a plurality of battery cells accommodated in a charging and discharging transport member into and out of the charging and discharging room through the inlets arranged to face each other, and is movable in the height direction of the first rack or the second rack and in a direction perpendicular to the height direction.

The battery manufacturing system may further include a transfer loading device that performs a first transfer to move the plurality of battery cells from a logistics transport portion accommodating the plurality of battery cells at a first preset spacing to a charging and discharging transport member accommodating the plurality of battery cells at a second preset spacing.

In addition, the transfer loading device may be capable of performing a second transfer to move the plurality of battery cells from the charging and discharging transport member to the logistics transport member, in the opposite operation to the first transfer.

On the other hand, the battery manufacturing system may further include an arrangement processing device arranging the plurality of logistics transport members, which are stacked in the height direction of the first rack or the second rack, to be spaced apart from each other in any one direction perpendicular to the height direction, or stacking the logistics transport members, which are spaced apart from each other in the any one direction, in the height direction, based on the direction of movement of the logistics transport members.

In addition, the battery manufacturing system may further include an input region and a discharge region which a logistics transport member accommodating the plurality of battery cells is input into and discharged from; and a logistics transport portion moving the logistics transport member accommodating the plurality of battery cells between the input region, the discharge region, and the transfer loading device.

In addition, the battery manufacturing system may further include an unloading portion positioned on the logistics transport portion and selectively allowing the logistics transport member to be removed from the logistics transport portion, when the logistics transport member moves by the logistics transport portion.

Meanwhile, the battery manufacturing system may further include: a first transfer loading device and a second transfer loading device which perform a first transfer of moving the plurality of battery cells from a logistics transport member accommodating the plurality of battery cells at a preset first spacing to the charging and discharging transport member accommodating the plurality of battery cells at a preset second spacing, and a second transfer of moving the plurality of battery cells from the charging and discharging transport member to the logistics transport member in the opposite direction of the first transfer; and a connecting belt portion connecting the first transfer loading device and the second transfer loading device; wherein the logistics transport member accommodating the plurality of battery cells performs the first transfer in any one of the first transfer loading device or the second transfer loading device, and then moves to another transfer loading device through the connecting belt portion and then performs the second transfer.

Meanwhile, a controlling method of the battery manufacturing system according to the present disclosure includes: a step of moving the transport crane in the horizontal and vertical directions to move the plurality of battery cells into one of the plurality of charging and discharging rooms; and a step of introducing the plurality of battery cells moved by the transport crane into one of the charging and discharging rooms.

In addition, the battery controlling method may further include a step of moving the plurality of battery cells from a logistics transport member accommodating the same to a charging and discharging transport member through a transfer loading device, prior to the step of moving into one of the charging and discharging rooms.

In addition, the controlling method of the battery manufacturing system may further include a step of separating the logistics transport members stacked in the height direction of the first rack or the second rack and arranging in any one direction perpendicular to the height direction through an arrangement processing device, prior to the step of moving to the charging and discharging transport member.

Meanwhile, a controlling method of the battery manufacturing system may further include a step of moving another plurality of battery cells withdrawn from the charging and discharging device to a logistics transport member which is empty inside through the transfer loading device, after the step of moving to the charging and discharging transport member.

In addition, the controlling method of the battery manufacturing system may further include: a step of moving the logistics transport member, which is empty inside, to another transfer loading device; and a step of moving another plurality of battery cells withdrawn from the charging and discharging device to the logistics transport member through the other transfer loading device, after the step of moving to the charging and discharging transport member.

According to one embodiment of the present disclosure, the space where a charging and discharging device is positioned can be efficiently utilized.

According to another embodiment of the present disclosure, the transport efficiency can be improved by organically utilizing a transport member in a charging and discharging process.

According to still another embodiment of the present disclosure, a transport member can be removed separately when a defect is generated in a charging and discharging process.

According to yet embodiment of the present disclosure, the production efficiency of the battery manufacturing system can be increased, and the battery manufacturing system can be stably controlled.

### BRIEF DESCRIPTION OF THE DRAWINGS

FIG. 1 shows an example of a battery cell according to the present disclosure.

FIG. 2 shows an example of a transport member according to the present disclosure.

FIG. 3 shows a top view of an example of a transport member according to the present disclosure.

FIG. 4 shows an example of a transport crane according to the present disclosure.

FIG. 5 shows a schematic diagram illustrating a process of moving a battery cell accommodated in a logistics transport member to a charging and discharging transport member using an arrangement processing device and a transfer loading device.

FIG. 6 shows an example of a battery manufacturing system according to the present disclosure.

FIG. 7 shows an example of a charging and discharging device according to the present disclosure.

FIG. 8 shows a flowchart illustrating an example of a controlling method of the battery manufacturing system according to the present disclosure.

FIG. 9 shows a flowchart illustrating another example of a controlling method of the battery manufacturing system according to the present disclosure.

FIG. 10 shows a flowchart illustrating still another example of a controlling method of the battery manufacturing system according to the present disclosure.

### DETAILED DESCRIPTION

Hereinafter, preferred embodiments of the present disclosure will be described in detail with reference to the attached drawings. The configuration or control method of the apparatus described below is only for explaining the embodiments of the present disclosure and is not intended to limit the scope of the present disclosure, and the same reference numerals used throughout the specification indicate the same components.

Specific terms used in the present specification are merely for convenience of explanation and are not used to limit the illustrated embodiments.

For example, expressions such as “same” and “is the same” not only indicate a strictly identical state, but also indicate a state in which there is a difference in tolerance or the degree to which the same function is obtained.

For example, expressions representing relative or absolute arrangement such as “in a certain direction,” “along a certain direction,” “side by side,” “perpendicularly,” “at the center,” “concentric,” or “coaxial,” not only strictly represent the arrangement, but also represent the state of relative displacement with a tolerance, or an angle or distance at which the same function is obtained.

To explain the present disclosure, it will be described below based on a spatial orthogonal coordinate system with X, Y, and Z axes orthogonal to each other. Unless otherwise specified, the Z direction refers to the height direction, the X-direction (or first direction) refers to any one of the directions perpendicular to the height direction, and the Y-direction (or second direction) refers to a direction perpendicular to the Z-direction and the X-direction.

However, the X-direction, Y-direction, and Z-direction mentioned below are for explanation so that the present disclosure may be clearly understood, and of course, the directions may be defined differently depending on where the reference is placed.

The use of terms such as ‘first, second, and third’ in front of the components mentioned below is only to avoid confusion about the components to which they are referred and is irrelevant to the order, importance, or master-slave relationship between the components, etc. For example, an invention that includes only a second component without a first component may also be implemented.

As used in this specification, singular expressions include plural expressions unless the context clearly dictates otherwise.

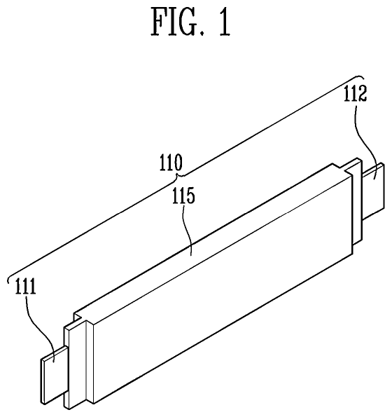

FIG. 1 shows an example of a battery cell 110 according to the present disclosure.

FIG. 1 illustrates a pouch-type battery cell as an example of a battery cell 110 according to the present disclosure, but a battery manufacturing system according to the present disclosure may also be applied to other types of battery cells, such as prismatic battery cells or cylindrical battery cells.

The battery cell 110 according to the present disclosure may include a main body portion 115 including an electrode assembly (not shown) that produces or stores electric energy therein, and a tab portion 111 and 112 which is electrically connected to the electrode assembly and protrudes outward from the main body 115.

A battery manufacturing system 1000 that mass-produces the above battery cell 110 may include multiple processes and devices. Therefore, since it is inefficient to move the battery cell 110 one by one between processes or devices, the battery manufacturing system 1000 may utilize a transport member (or tray) that accommodates and moves a plurality of battery cells 110 at a time.

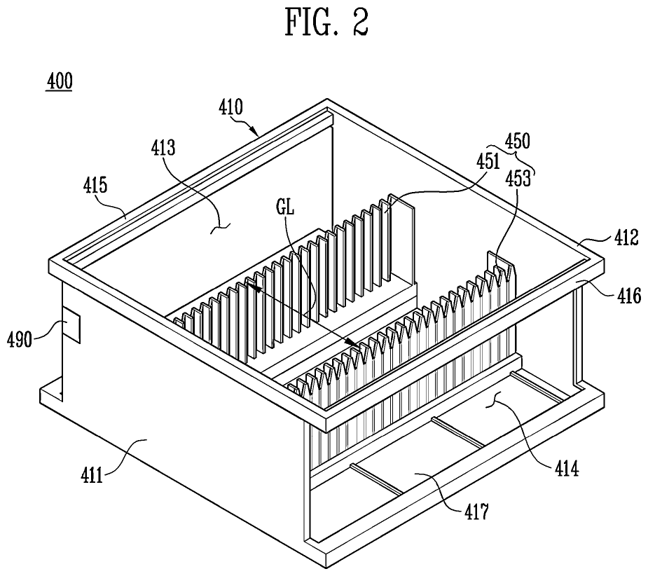

FIG. 2 shows an example of a transport member according to the present disclosure.

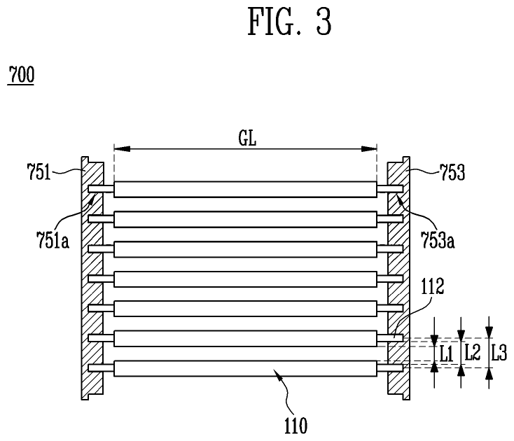

Specifically, FIG. 2 illustrates an example of a logistics transport member 400 according to the present disclosure. A battery manufacturing system 1000 according to the present disclosure may utilize two different types of transport members (or trays). For example, one type of transport member may be a press pre-charger (PPC, or charging and discharging device 900), which refers to a charging and discharging transport member 700 (see FIG. 3) used when transporting a battery cell 110, and the other type of transport member refers to a logistics transport member 400 used when transporting a battery cell 110 in another process or device. In FIG. 2, an example of the logistics transport member 400 is first described, but since the description of the structure and function of the logistics transport member 400 may be equally applied to the charging and discharging transport member 700, unless otherwise specified, the description of the shape of the logistics transport member 400 may also be applied to the charging and discharging transport member 700.

Referring to FIG. 2, the logistics transport member 400 (or tray) may be used to accommodate a battery cell 110 (see FIG. 1) and move the battery cell from one device to another. In other words, it may be more advantageous in terms of manufacturing process efficiency to bundle a plurality of battery cells 110 into one unit and move them rather than moving individual battery cells 110.

To this end, the logistics transport member 400 may include: a transport case 410 having an open top; and a grip portion 450 positioned inside the transport case 410 to detachably fix the battery cells 110.

The transport case 410 may be provided in a box shape to accommodate a plurality of battery cells 110 therein. The transport case 410 may include: a transport floor panel 417 supporting the grip portion 450; and a first extending panel 411 and a second extending panel 412 facing each other and extending upwardly from facing edges of the transport floor panel 417.

In addition, a first connecting portion 415 and a second connecting portion 416 connecting the first extending panel 411 and the second extending panel 412 may be included. The first connecting portion 415 and the second connecting portion 416 may also be arranged in parallel to face each other.

In addition, the logistics transport member 400 may include a first opening 413 positioned between the first connecting portion 415 and the transport floor panel 417 and connecting the interior and the exterior of the transport case 410. Likewise, the logistics transport member 400 may include a second opening 414 positioned between the second connecting portion 416 and the transport floor panel 417 and connecting the interior and the exterior of the transport case 410.

The first connecting portion 415 and the second connecting portion 416 may have the same shape. Likewise, the first extending panel 411 and the second extending panel 412 may have the same shape.

The logistics transport member 400 may be moved between individual devices using a moving system such as a conveyor belt. In addition, the logistics transport member 400 may be stacked and moved. To this end, the shape of a transport floor panel 417 of any one transport case 410 may be provided to correspond to the shape of an upper surface of another transport case 410 so that they may be fitted together.

The grip portion 450 may fix the battery cell 110 to the inside of the transport case 410. At this time, the transport floor panel 417 may support the grip portion 450 and a battery cell 110 fixed by the grip portion 450.

Along a protruding direction in which the tab portions 111 and 112 protrude, the grip portion 450 may be in contact with both ends of the battery cell 110 to detachably fix the battery cell 110 to the inside of the logistics transport member 400. This is to prevent the battery cell 110 from shaking and falling over during movement and colliding with another adjacent battery cell 110 and being damaged.

Meanwhile, the length of both ends of the battery cell 110 may be different along the protruding direction. This is because the specifications of the battery cell 110 may vary depending on the environment or device in, or the purpose for, which the battery cell 110 is used.

When the length of the battery cell 110 along the protruding direction is referred to as the width, the battery cell 110 may be classified into a long-width battery cell and a short-width battery cell depending on the relative size of the width.

Therefore, the logistics transport member 400 may adjust the length GL between the grip portions 450 according to the width of the battery cell in order to transport both the long-width battery cell and the short-width battery cell.

In other word, the grip portion 450 may be in contact with at least one tab portion 111 and 112 along the protruding direction. To this end, the grip portion 450 may include a first grip 451 and a second grip 453 that are movable so as to be in contact with the tab portion 111 and 112 along the protruding direction.

The first grip 451 and the second grip 453 may be in contact with a region including both ends of the battery cell 110 along the protruding direction, thereby detachably fixing the battery cell 110 to the interior of the logistics transport member 400.

Meanwhile, the logistics transport member 400 may include an information portion 490 attached to the transport case 410 and containing information including the type of battery cell 110 accommodated in the logistics transport member 400. The information portion 490 may be a barcode positioned on the surface of the transport case 410, or may be a chip or tag using a radio frequency identification (RFID) method embedded in the transport case 410.

The battery manufacturing system 1000 may scan the information of the barcode or read the information of the chip to know the type of battery cell 110 accommodated in the logistics transport member 400.

FIG. 3 shows a top view of an example of a transport member according to the present disclosure.

Specifically, FIG. 3 illustrates an example of a charging and discharging transport member 700 according to the present disclosure.

Referring to FIG. 3, an example is shown in which a plurality of battery cells 110 are accommodated in the charging and discharging transport member 700. Each tab portion 111 and 112 of the plurality of battery cells 110 may be inserted and fixed into a first groove 751a formed in a first grip 751 of the charging and discharging transport member 700 and a second groove 753a formed in a second grip 753 of the charging and discharging transport member 700. The first groove 751a and the second groove 753a may be provided in the same shape also in the logistics transport member 400.

The charging and discharging transport member 700 used in a charging and discharging process may have a different arrangement spacing of battery cells 110 from that of the logistics transport member 400 in consideration of heat generation and swelling of battery cells 110 that occur during pressurized charging and discharging.

Here, the arrangement spacing refers a spacing between the battery cells 110 accommodated in the charging and discharging transport member 700 or the logistics transport member 400, and may be the spacing L1 between one surface forming a main body 115 (see FIG. 1) of one battery cell 110 and one surface of both surfaces of a main body 115 of another adjacent battery cell 110, the one surface being positioned closer to the one surface of the one battery cell 110. Alternatively, the arrangement spacing may be a spacing L2 between one surface of a tab portion of one battery cell 110 and one surface of both surfaces of a tab portion of another adjacent battery cell 110, the one surface being positioned closer to the one surface of the one battery cell 110. On the contrary, the arrangement spacing may be the distance L3 between the center of a tab portion of one battery cell 110 and the center of a tab portion of another battery cell 110 adjacent to the one battery cell 110. This may be a spacing between first grooves 751a when the first grooves 751a are provided in a plural number. Alternatively, this may be a spacing between first grooves 753a when the second grooves 753a are provided in a plural number.

For example, the arrangement spacing of the battery cell 110 in the charging and discharging transport member 700 may be larger than the arrangement spacing of the battery cell 110 in the logistics transport member 400. For example, the arrangement spacing between the battery cells 110 in the charging and discharging transport member 700 may be at least twice the arrangement spacing between the battery cells 110 in the logistics transport member 400.

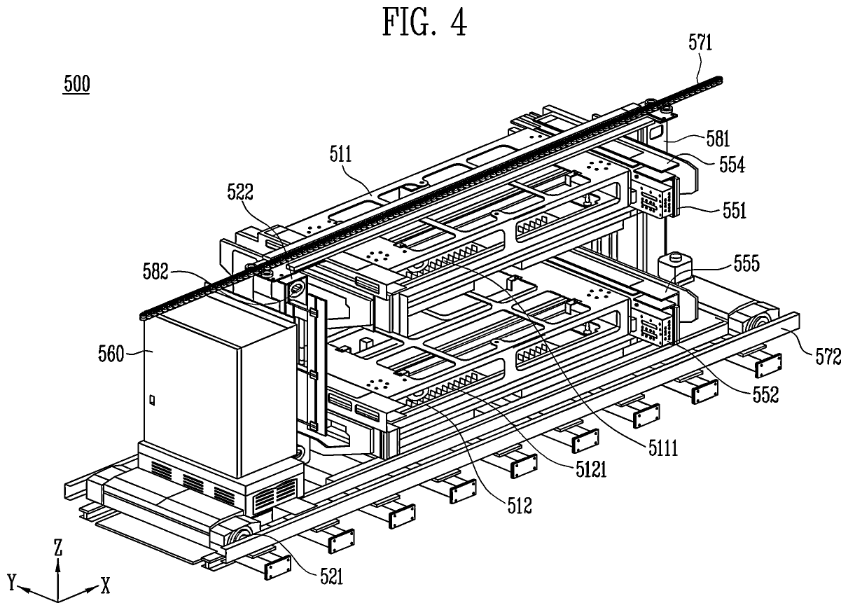

FIG. 4 shows an example of a transport crane 500 according to the present disclosure. Referring to FIG. 4, a battery manufacturing system 1000 according to the present

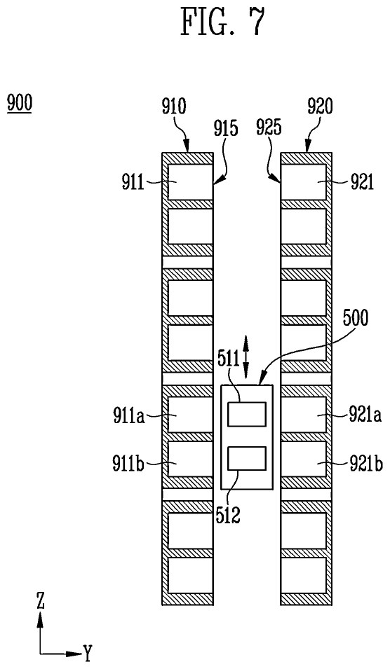

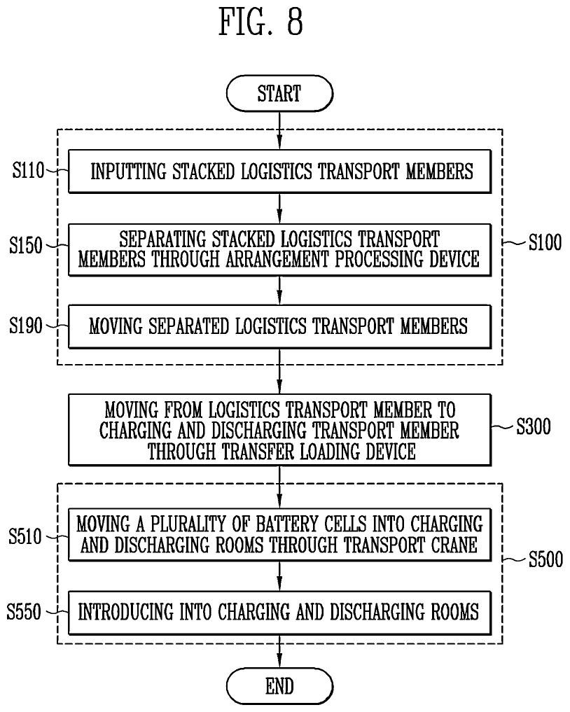

disclosure includes a transport crane 500 which is provided between a first rack 910 and a second rack 920 of a charging and discharging device 900 (see FIG. 7), introduces and withdraws a plurality of battery cells 110 through each inlet of the first rack 910 (see FIG. 7) and the second rack (see FIG. 8) arranged to face each other, and is movable in the height direction (e.g., Z-direction) of the first rack 910 and the second rack 920 and in the direction perpendicular to the height direction (e.g., X-direction).

The transport crane 500 may be positioned between the first rack 910 and the second rack 920 and move a plurality of battery cells 110 accommodated in the charging and discharging transport member 700 along any one of the directions perpendicular to the height direction to any one of the charging and discharging rooms 911 and 921 of the first rack 910 or the second rack 920.

In other words, the transport crane 500 may lift the plurality of battery cells 110 from the charging and discharging transport member 700, and then receive the input of the positions of the charging and discharging rooms 911 and 921 of the first rack 910 or the second rack and move in the horizontal and vertical directions of the first rack 910 or the second rack 920, thereby moving the charging and discharging transport member 700, which is loaded on the transport crane 500 and accommodates the plurality of battery cells 110, to the front of the charging and discharging rooms 911 and 921 of which the input of the positions have been received.

To this end, the transport crane 500 may include: a first frame 511 and a second frame 512 lifting and transporting the plurality of battery cells 110; and a first mast 581 and a second mast 582 supporting the first frame 511 and the second frame 512 and moving the first frame 511 and the second frame 512 in the height direction.

In addition, the transport crane 500 may include a first guide portion 571 and a second guide portion 572 for moving the transport crane 500 in any one of the directions perpendicular to the height direction. The first frame 511 and the second frame 512 may be positioned between the first guide portion 571 and the second guide portion 572.

The first frame 511 and the above second frame 512 may be arranged to correspond to two charging and discharging rooms 911a and 911b or 921a and 921b (see FIG. 7) that are arranged adjacently along the height direction of the first rack 910 (see FIG. 7) and the second rack 920 (see FIG. 7).

The first frame 511 and the second frame 512 may include a first fork portion 551 and a second fork portion 552 that may move along respective rails 554 and 555 toward or away from the charging and discharging rooms 911 and 921. The transport crane 500 may introduce or withdraw the plurality of battery cells 110 loaded on the transport crane 500 into or from two charging and discharging rooms 911a and 911b or 921a and 921b that are adjacent in the height direction among the plurality of charging and discharging rooms 911 and 921 through the first fork portion 551 and the second fork portion 552.

The first frame 511 may further include a first gripper 5111 capable of individually lifting a plurality of battery cells 110 accommodated in the charging and discharging transport member 700. Likewise, the second frame 512 may further include a second gripper 5121 capable of individually lifting a plurality of battery cells 110 accommodated in the charging and discharging transport member 700.

The transport crane 500 uses a method of lifting the plurality of battery cells 110 from the charging and discharging transport member 700 and introducing them into the charging and discharging rooms 911 and 921, or withdrawing them from the charging and discharging rooms 911 and 921 and moving them to the charging and discharging transport member 700, which may be referred to as a pick-and-place method.

The transport crane 500 may include a first driving portion 521 moving the first frame 511 and the second frame 512 along the first guide portion 571 and the second guide portion 572, and a second driving portion 522 that moves the first frame 511 and the second frame 512 along the first mast 581 and the second mast 582. In addition, separate driving portions (not shown) moving the first fork portion 551 and the first gripper 5111 and moving the second fork portion 552 and the second gripper 5121 may be further included.

In addition, the transport crane 500 may further include a control portion 560 controlling the first driving portion 521, the second driving portion 522, the first fork portion 551, the first gripper 5111, the second fork portion 552, and the second gripper 5121. The control portion 560 may introduce a plurality of battery cells 110 into targeted charging and discharging rooms 911 and 921, or may withdraw a plurality of battery cells 110 accommodated in the charging and discharging rooms 911 and 921 and move them to the charging and discharging transport member 700 according to a control signal.

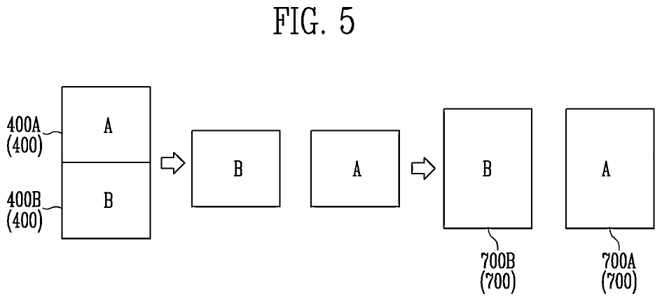

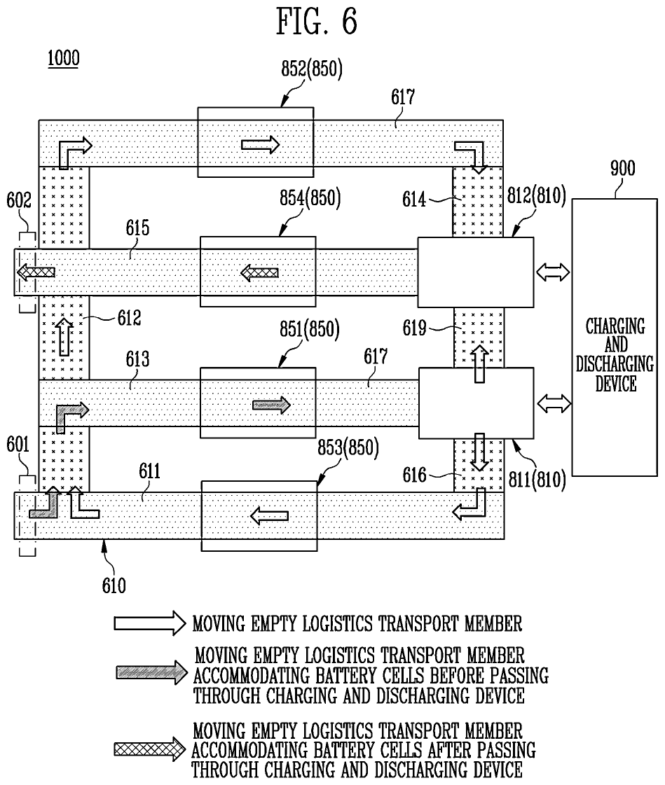

FIG. 5 shows a schematic diagram illustrating a process of moving a battery cell accommodated in a logistics transport member 400 to a charging and discharging transport member 700 using an arrangement processing device 850 and a transfer loading device 810. FIG. 6 shows an example of a battery manufacturing system 1000 according to the present disclosure.

As described above, the arrangement spacing of the plurality of battery cells 110 accommodated in the logistics transport member 400 and the charging and discharging transport member 700 may be different from each other.

The arrangement spacing of the plurality of battery cells 110 in the logistics transport member 400 is herein referred to as a first spacing, and the arrangement spacing of the plurality of battery cells 110 in the charging and discharging transport member 700 is referred to as a second spacing.

Referring to FIGS. 5 and 6, the battery manufacturing system 1000 may further include a transfer loading device 810 moving the plurality of battery cells 110 from the logistics transport member 400, which accommodates the plurality of battery cells 110 at a first preset spacing, to the charging and discharging transport member 700, which accommodates the plurality of battery cells 110 at a second preset spacing.

Moving the plurality of battery cells 110 from the logistics transport member 400 to the charging and discharging transport member 700 by the transfer loading device 810 may be referred to as a first transfer step (or first transfer). Through the first transfer step, the plurality of battery cells 110 are moved from the logistics transport member 400 to the charging and discharging transport member 700, so that the spacing of the plurality of battery cells 110 will change from the first spacing to the second spacing.

In addition, the transfer loading device 810 may also move the plurality of battery cells 110 withdrawn from the charging and discharging rooms 911 and 921 in an opposite direction from the charging and discharging transport member 700, which accommodates battery cells at the second spacing, to the logistics transport member 400, which accommodates battery cells at the first spacing.

In other words, moving the plurality of battery cells 110 from the charging and discharging transport member 700 to the logistics transport member 400 by the transfer loading device 810, as the opposite of the first transfer step (or first transfer), may be referred to as a second transfer step (or second transfer). The transfer loading device 810 may perform both the first transfer and the second transfer.

Through the second transfer step, the plurality of battery cells 110 are moved from the charging and discharging transport member 700 to the logistics transport member 400, so that the spacing of the plurality of battery cells 110 will change from the second spacing to the first spacing.

Referring to FIGS. 5 and 6, the logistics transport member 400 may be introduced into the battery manufacturing system 1000 in a stacked form to increase the efficiency of transport. Therefore, the battery manufacturing system 1000 may further include an arrangement processing device 850 separating logistics transport members 400 stacked in the height direction of the first rack or the second rack and arranging them in any one direction perpendicular to the height direction.

Alternatively, in contrast to the above description, the arrangement processing device 850 may stack the logistics transport members 400, which are arranged to be spaced apart in any one direction, in the height direction. The operation of the arrangement processing device 850 may vary depending on whether the logistics transport members 400 are stacked and the moving direction of the logistics transport member 400.

Referring to FIG. 5, the stacked and introduced logistics transport members 400A and 400B may be separated and arranged apart through the arrangement processing device 850 in a horizontal direction. Thereafter, each of the separated and spaced logistics transport members 400A and 400B will be sequentially moved to and accommodated in the charging and discharging transport members 700A and 700B through the transfer loading device 810.

Thereafter, the transport crane 500 will lift a plurality of battery cells 110 accommodated in the charging and discharging transport member 700 using a first gripper 5111 and a second gripper 5121, and then introduce them into targeted charging and discharging rooms 911 and 921.

The plurality of battery cells 110 withdrawn from the charging and discharging rooms 911 and 921 will be finally moved to the logistics transport member 400 in an order opposite to the above-described order. In other words, the plurality of battery cells 110 withdrawn from the charging and discharging rooms 911 and 921 will be moved from the charging and discharging transport member 700, which accommodates at a second spacing, to the logistics transport member 400, which accommodates at a first spacing, through the transfer loading device 810

Based on the direction in which the plurality of battery cells 110 introduced through the input region 601 move to the charging and discharging device 900, the transfer loading device 810 will be arranged in the battery manufacturing system 1000 before the transport crane 500 transports the plurality of battery cells 110 from the charging and discharging transport member 700 to the charging and discharging rooms 911 and 921. Likewise, based on the direction in which the plurality of battery cells 110 introduced

through the input region 601 move to the charging and discharging device 900, the arrangement processing device 850 may be arranged in the battery manufacturing system 1000 before the logistics transport member 400 moves to the transfer loading device 810.

Referring to FIG. 6, the battery manufacturing system 1000 may further include: an input region 601 and a discharge region 602 in which the logistics transport member 400 accommodating the plurality of battery cells 110 is input and discharged; and logistics transport portions 611 to 617 moving the logistics transport member 400 accommodating the plurality of battery cells 110 between the input region 601, the discharge region 602, and the transfer loading device 810.

Considering the arrangement processing device 850, the battery manufacturing system 1000 may further include: an input region 601 and a discharge region 602 in which the logistics transport member 400 accommodating the plurality of battery cells 110 is input and discharged; and logistics transport portions 611 to 617 moving the logistics transport member 400 accommodating the plurality of battery cells 110 between the arrangement processing device 850 and the transfer loading device 810.

Based on the direction in which the plurality of battery cells 110 introduced through the input region 601 move to the charging and discharging device 900, the input region 601 is an arbitrary region positioned on the logistics transport portions 611 to 617 before the logistics transport member 400 passes through the arrangement processing device 850 and the transfer loading device 810. The logistics transport portions 611 to 617 includes a first moving belt 611, a second moving belt 612, a third moving belt 613, a fourth moving belt 614, a fourth moving belt 615, a sixth moving belt 616, and a seventh moving belt 617.

The discharge region 602 is any other region positioned after passing through the arrangement processing device 850 and the transfer loading device 810. Therefore, the input region 601 and the discharge region 602 are not necessarily limited to referring to a specific space.

Meanwhile, for mass production of the battery cell 110, the battery manufacturing system 1000 may include a plurality of transfer loading devices 810, a plurality of arrangement processing devices 850, and logistics transport portions 611 to 617 that connect each of them.

For example, referring to FIG. 6, the plurality of transfer loading devices 810 may include a first transfer loading device 811 and a second transfer loading device 812 moving the plurality of battery cells 110 from a logistics transport member 400, which accommodates the plurality of battery cells 110 at a preset first spacing, to a charging and discharging transport member 700, which accommodates the plurality of battery cells 110 at a preset second spacing.

In addition, referring to FIG. 6, the plurality of arrangement processing devices 850 may include a first arrangement processing device 851, a second arrangement processing device 852, a third arrangement processing device 853, and a fourth arrangement processing device 854 that are connected to the first transfer loading device 811 and the second transfer loading device 812. Each of the arrangement processing devices 851 to 854 will be organically connected to the first transfer loading device 811 and the second transfer loading device 812 by the logistics transport portions 611 to 617.

For the above organic connection, the battery manufacturing system 1000 may further include a connecting belt portion 619 connecting the first transfer loading device 811 and the second transfer loading device 812.

The logistics transport member 400 accommodating the plurality of battery cells 110 may perform the first transfer step in one of the transfer loading devices of the first transfer loading device 811 or the second transfer loading device 812, and then move to another transfer loading device via the connecting belt portion 619 to perform the second transfer step.

For example, the logistics transport member 400 accommodating the plurality of battery cells 110 may unload the plurality of battery cells 110 from the first transfer loading device 811 and then move to the second transfer loading device 812 through the connecting belt portion 619 to accommodate the other plurality of battery cells 110.

Thereafter, the logistics transport member 400 accommodating the other plurality of battery cells 110 will move toward the discharge region 602 after passing through the fourth arrangement processing device 854 through the fifth moving belt 615. Referring to FIG. 6, stacked logistics transport members 400 may be introduced along

a first moving belt 611 through the input region 601, and then moved through a second moving belt 612 connected to the first moving belt 611. In addition, the stacked logistics transport members 400 may move along a third moving belt 613 connected to the second moving belt 612 and then be separated through a first arrangement processing device 851 arranged on the third moving belt 613.

Alternatively, without passing through the third moving belt 613, the stacked logistics transport members 400 may continue to move along the second moving belt 612 and then move along a seventh moving belt 617 connected to the second moving belt 612. In addition, the stacked logistics transport members 400 may be separated by a second arrangement processing device 852 arranged on the seventh moving belt 617 while moving along the seventh moving belt 617. Thereafter, the stacked logistics transport members may move to a second transfer loading device 812 through a fourth moving belt 614 connecting the seventh moving belt 617 and the second transfer loading device 812.

FIG. 6 illustrates that the input region 601 and the first arrangement processing device 851 are connected not only by the first moving belt 611 but also by a second moving belt 612 and a third moving belt 613 so that the logistics transport member 400 is moved (moving in the direction of the shaded arrow), but this is only an example, and they may be connected differently.

The logistics transport member 400 separated through the first arrangement processing device 851 continues to move through the third moving belt 613, thereby passing through a first transfer loading device 811. Through the first transfer loading device 811, a plurality of battery cells 110 accommodated inside may be moved to a charging and discharging transport member 700.

Thereafter, the plurality of battery cells 110 accommodated in the charging and discharging transport member 700 will be moved to the charging and discharging device 900 through the transport crane 500 (see FIG. 4).

Meanwhile, a logistics transport member 400, the interior of which has been emptied through a first transfer loading device 811, may accommodate again a plurality of battery cells 110 that have passed through a charging and discharging device 900 through the first transfer loading device 811, and then change into a stacked form again by passing through a third arrangement processing device 853 through a sixth transfer belt 616 and a first transfer belt 611 connected to the sixth transfer belt 616, and then be removed through the discharge region 602.

Alternatively, considering process efficiency, a logistics transport member 400, the interior of which has been emptied through the first transfer loading device 811, may move to the second transfer loading device 812 through a connecting belt portion 619, and then accommodate a plurality of battery cells 110 that have passed through a charging and discharging device 900 through the second transfer loading device 812. Thereafter, the logistics transport member 400 accommodating the plurality of battery cells 110 may move along a fifth moving belt 615, be stacked through a fourth arrangement processing device 854, and then be removed through the discharge region 602.

Alternatively, a logistics transport member 400, the interior of which has been emptied through the first transfer loading device 811, may move to the second transfer loading device 812 through a sixth moving belt 616, a first moving belt 611, a second moving belt 612, and a seventh moving belt 617. In other words, the movement of a logistics transport member 400 and the transfer position of the logistics transport member 400 and a charging and discharging transport member 700 may be immediately changed according to the current processing situation of a battery manufacturing system 1000.

In addition, the number of the transfer loading device 810 and the arrangement processing device 850 may be changed at any time according to the conditions of a battery manufacturing system 1000.

Meanwhile, the battery manufacturing system 1000 may further include an unloading portion (not shown) positioned on the logistics transport portion 611 to 617 to selectively allow the logistics transport member 400 to move away from the logistics transport portion 611 to 617 when the logistics transport member 400 is moved by the logistics transport portion 611 to 617. The unloading portion may prevent a logistics transport member 400 in which a defect has been generated from moving unnecessarily on the logistics transport portion 611 to 617, thereby enabling stable and flexible operation of the battery manufacturing system 1000.

FIG. 7 shows an example of a charging and discharging device 900 according to the present disclosure.

A plurality of battery cells 110 loaded on a charging and discharging transport member 700 through the transfer loading device 810 will be moved to the charging and discharging device 900 through a transport crane 500. The transport crane 500 will move the plurality of battery cells 110 to a charging and discharging room 911 and 921 of a first rack 910 or a second rack according to an input control signal.

Moving to the charging and discharging room 911 and 921 may mean that the transport crane 500 introduces the plurality of battery cells 110 through an inlet 915 and 925 of the charging and discharging room 911 and 921, or that the transport crane 500 withdraws the plurality of battery cells 110 accommodated in the charging and discharging room 911 and 921 through an inlet 915 and 925.

Referring to FIG. 7, the battery manufacturing system 1000 includes: a first rack 910 and a second rack 920, each of which includes a charging and discharging room 911 and 912 including an inlet 915 and 925 on one surface and accommodating a plurality of battery cells 110 through the inlet 915 and 925, and which are aligned in parallel with each other; and a transport crane 500, which is provided between the first rack 910 and the second rack 920, introduces and withdraws a plurality of battery cells 110 accommodated in a charging and discharging transport member 700 into and out of the charging and discharging room 911 and 912 through the inlet 915 of the first rack 910 and the inlet 925 of the second rack 920 arranged to face each other, and is movable in the height direction of the first rack 910 or the second rack 920 and in a direction perpendicular to the height direction.

The charging and discharging device 900 may include a first rack 910 and a second rack 920 in which charging and discharging rooms are stacked in the height direction (Z-direction). The first rack 910 and the second rack 920 may be positioned such that inlets 915 and 925 of the charging and discharging rooms 911 and 921 face each other. Therefore, between the first rack 910 and the second rack 920, the transport crane 500 may introduce or withdraw the plurality of battery cells 110 to or from the first rack 910 and the second rack 920. In other words, unlike the conventional method, the transport crane 500 may be capable of moving the plurality of battery cells 110 in both directions through a first fork portion 551 (see FIG. 4) and a second fork portion 552 (see FIG. 4). In other words, by using a single transport crane 500 capable of moving a plurality of battery cells 110 to a first rack 910 and a second rack 920 positioned on both sides, the space occupied by the charging and discharging device 900 can be utilized more efficiently.

Meanwhile, the charging and discharging rooms 911 and 921 may also be arranged in a direction perpendicular to the height direction (Z-direction) and to the direction facing the inlets 915 and 925. Therefore, the first rack 910 and the second rack 920 may include a plurality of charging and discharging rooms 911 and 921 in the horizontal and vertical directions.

FIG. 8 shows a flowchart illustrating an example of a controlling method of the battery manufacturing system 1000 according to the present disclosure.

As described above, the control method of the battery manufacturing system 1000 includes a step S510 of moving the transport crane 500 (see FIG. 4) in the horizontal and vertical directions to move a plurality of battery cells 110 (see FIG. 1) into one of the plurality of charging and discharging rooms 911 and 921 (see FIG. 7), and a step S550 of introducing the plurality of battery cells 110 moved by the transport crane 500 into one of the charging and discharging rooms 911 and 921.

The step S510 of moving a plurality of battery cells 110 to one of the plurality of charging and discharging rooms 911 and 921 and the step S550 of introducing the plurality of battery cells 110 moved by the transport crane 500 into one of the charging and discharging rooms 911 and 921 may be collectively referred to as a step S500 of moving a plurality of battery cells 110 to a charging and discharging device 900.

In addition, the controlling method of the battery manufacturing system 1000 may further include a step S300 of moving the plurality of battery cells 110 from a logistics transport member 400 (see FIG. 2) to the charging and discharging transport member 700 (see FIG. 3) through a transfer loading device 810 (see FIG. 6), prior to the step S300 of moving into one of the charging and discharging rooms 911 and 921.

In addition, the controlling method of the battery manufacturing system 1000 may further include a step S100 of separating the logistics transport members 400 stacked in the height direction of the first rack 910 or the second rack 920 and arranging in any one direction perpendicular to the height direction through an arrangement processing device 850 (see FIG. 6), prior to the step S300 of moving to the charging and discharging transport member 700.

The step S100 of separating the logistics transport members 400 stacked in the height direction of the first rack 910 (see FIG. 7) or the second rack 920 (see FIG. 7) and arranging in any one direction perpendicular to the height direction through the arrangement processing device 850 may further include a step S110 of inputting the stacked logistics transport members 400 through an input region 601 (see FIG. 6), a step S150 of separating the stacked logistics transport members 400 through the arrangement processing device 850, and a step S190 of moving the separated logistics transport members 400 toward the transfer loading device 810.

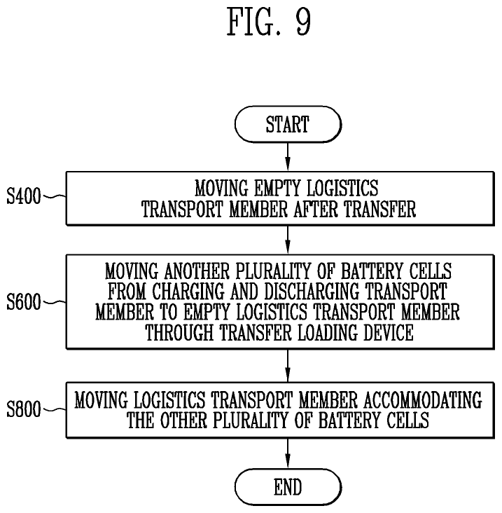

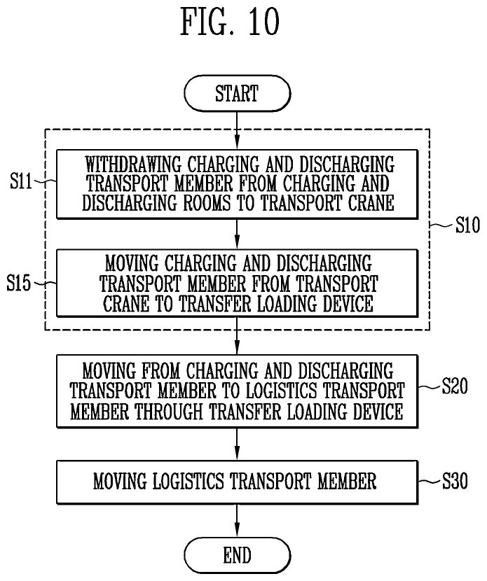

The flowchart illustrated in FIG. 8 has been described with reference to FIG. 6, so a duplicate detailed description has been omitted. A detailed description has also been omitted for the same reason for FIGS. 9 and 10, which will be described later.

FIG. 9 shows a flowchart illustrating another example of a controlling method of the battery manufacturing system 1000 according to the present disclosure.

Specifically, while FIG. 8 relates to a controlling method of moving a plurality of battery cells 110 to a charging and discharging device 900 (see FIG. 6), FIG. 9 relates to a controlling method of moving a logistics transport member 400 that has become empty after moving a plurality of battery cells 110.

In the step S300 of moving the plurality of battery cells 110 from the logistics transport member 400 (see FIG. 2) accommodating the battery cells to the charging and discharging transport member 700 (see FIG. 3) through the transfer loading device 810 (see FIG. 6), illustrated in FIG. 8, when the plurality of battery cells 110 are transferred, an empty logistics transport member 400 will be generated. In order to utilize the empty logistics transport member 400, the controlling method of the battery manufacturing system 1000 may include a step S400 of moving the empty logistics transport member 400 after the transfer, a step S600 of moving another plurality of battery cells from a charging and discharging transport member 700 accommodating the battery cells to the empty logistics transport member 400 through the transfer loading device, and a step S800 of moving the logistics transport member accommodating the other plurality of battery cells toward a discharge region 602.

The other plurality of battery cells 110 may refer to battery cells 110 that are withdrawn by a transport crane 500 through the charging and discharging device 900 and moved to and accommodated in the charging and discharging transport member 700.

FIG. 10 shows a flowchart illustrating still another example of a controlling method of the battery manufacturing system 1000 according to the present disclosure.

After moving a plurality of battery cells 110 withdrawn from the charging and discharging rooms 911 and 921 to the charging and discharging transport member 700 through the transport crane 500, the battery manufacturing system 1000 needs to move the battery cells from the charging and discharging transport member 700 to the logistics transport member 400 through the transfer loading device 810. FIG. 10 relates to a controlling method for this.

The controlling method of the battery manufacturing system 1000 may include a step S10 of moving from the charging and discharging rooms 911 and 921 to the charging and discharging transport member 700 through the transport crane 500, a step S20 of moving the plurality of battery cells 110 from the charging and discharging transport member 700 to the logistics transport member 400 through the transfer loading device 810, and a step S30 of moving the logistics transport member 400 toward the discharge region 602.

The step S10 of moving from the charging and discharging rooms 911 and 921 to the charging and discharging transport member 700 through the transport crane 500 may include a step S11 of withdrawing the charging and discharging transport member 700 from the charging and discharging rooms 911 and 921 to the transport crane 500, and a step S15 of moving the withdrawn charging and discharging transport member 700 accommodating plurality of battery cells 110 to the transfer loading device 810 from the transport crane 500.

The present disclosure may be modified and implemented in various forms, and its scope is not limited to the embodiments described above. Therefore, if a modified embodiment includes components of the present disclosure, it should be regarded as falling within the scope of the rights of the present disclosure.

What is claimed is:

1. A battery manufacturing system comprising:
a first rack and a second rack, each of which includes a charging and discharging room including an inlet on one surface and accommodating a plurality of battery cells through the inlet, and which are aligned in parallel with each other; and
a transport crane, which is provided between the first rack and the second rack, introduces and withdraws a plurality of battery cells accommodated in a charging and discharging transport member into and out of the charging and discharging room through the inlets arranged to face each other, and is movable in the height direction of the first rack or the second rack and in a direction perpendicular to the height direction.

2. The battery manufacturing system according to claim 1, further comprising: a transfer loading device that performs a first transfer to move the plurality of battery cells from a logistics transport portion accommodating the plurality of battery cells at a first preset spacing to a charging and discharging transport member accommodating the plurality of battery cells at a second preset spacing.

3. The battery manufacturing system according to claim 2, wherein the transfer loading device is capable of performing a second transfer to move the plurality of battery cells from the charging and discharging transport member to the logistics transport member, in the opposite operation to the first transfer.

4. The battery manufacturing system according to claim 2, further comprising:
an arrangement processing device arranging the plurality of logistics transport members, which are stacked in the height direction of the first rack or the second rack, to be spaced apart from each other in any one direction perpendicular to the height direction, or stacking the logistics transport members, which are spaced apart from each other in the any one direction, in the height direction, based on the direction of movement of the logistics transport members.

5. The battery manufacturing system according to claim 2, further comprising:
an input region and a discharge region which a logistics transport member accommodating the plurality of battery cells is input into and removed from; and
a logistics transport portion moving the logistics transport member accommodating the plurality of battery cells between the input region, the discharge region, and the transfer loading device.

6. The battery manufacturing system according to claim 5, further comprising:
an unloading portion positioned on the logistics transport portion and selectively allowing the logistics transport member to be removed from the logistics transport portion, when the logistics transport member moves by the logistics transport portion.

7. The battery manufacturing system according to claim 1, further comprising:
a first transfer loading device and a second transfer loading device which perform a first transfer of moving the plurality of battery cells from a logistics transport member accommodating the plurality of battery cells at a preset first spacing to the charging and discharging transport member accommodating the plurality of battery cells at a preset second spacing, and a second transfer of moving the plurality of battery cells from the charging and discharging transport member to the logistics transport member in the opposite direction of the first transfer; and
a connecting belt portion connecting the first transfer loading device and the second transfer loading device;
wherein the logistics transport member accommodating the plurality of battery cells performs the first transfer in any one of the first transfer loading device or the second transfer loading device, and then moves to another transfer loading device through the connecting belt portion and then performs the second transfer.

8. A controlling method of a battery manufacturing system including a charging and discharging device, the device including: a first rack and a second rack including a plurality of charging and discharging rooms which include an inlet on one surface and accommodate a plurality of battery cells each accommodated therein through the inlet, and which are aligned in the horizontal and vertical directions; and a transport crane, which is positioned between the first rack and the second rack,
the controlling method comprising:
a step of moving the transport crane in the horizontal and vertical directions to move the plurality of battery cells into one of the plurality of charging and discharging rooms; and
a step of introducing the plurality of battery cells moved by the transport crane into one of the charging and discharging rooms.

9. The controlling method of the battery manufacturing system according to claim 8, further comprising: a step of moving the plurality of battery cells from a logistics transport member accommodating the same to a charging and discharging transport member through a transfer loading device, prior to the step of moving into one of the charging and discharging rooms.

10. The controlling method of the battery manufacturing system according to claim 9, further comprising: a step of separating the logistics transport members stacked in the height direction of the first rack or the second rack and arranging in any one direction perpendicular to the height direction through an arrangement processing device, prior to the step of moving to the charging and discharging transport member.

11. The controlling method of the battery manufacturing system according to claim 9, further comprising: a step of moving another plurality of battery cells withdrawn from the charging and discharging device to a logistics transport member which is empty inside through the transfer loading device, after the step of moving to the charging and discharging transport member.

12. The controlling method of the battery manufacturing system according to claim 9, further comprising:
a step of moving the logistics transport member, which is empty inside, to another transfer loading device; and
a step of moving another plurality of battery cells withdrawn from the charging and discharging device to the logistics transport member through the other transfer loading device, after the step of moving to the charging and discharging transport member.
